(19) United States
(12) Patent Application Publication
(10) Pub. No.: US 2009/0151969 A1
(43) Pub. Date: Jun. 18, 2009

(54) ELECTRIC SCREWDRIVER

(75) Inventor: ER-PENG HUANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/331,378

(22) Filed: Dec. 9, 2008

(30) Foreign Application Priority Data
Dec. 14, 2007 (CN) 200710203081.5

(51) Int. Cl. B23Q 5/10; B25B 21/00

(52) U.S. Cl. 173/217; 81/57.13

(57) ABSTRACT

An electric screwdriver is configured for fastening a screw in an apparatus. The driving part is configured for generating rotary motion. The driven part is configured for fastening the screw in the apparatus using the rotary motion. The transmission part nonlinearly connects the driving part and the driven part. The transmission part is capable of transmitting the rotary motion from the driving part to the transmission part.

### BACKGROUND

1. Field of the Disclosure

The present disclosure generally relates to screwdrivers, particular relates to an electric screwdriver used in various assembly circumstances.

2. Description of Related Art

Screwdrivers are devices specifically designed to insert and tighten, or to loosen and remove screws. The screwdrivers are rotated manually or by electric motors. Those using electric motors are also called electric screwdrivers.

Referring to FIG. 6, an electric screwdriver 10 is used for fastening a screw 30 to a housing 20. The electric screwdriver 10 includes a mainbody 12 and a detachable head 14. The mainbody 12 and the detachable head 14 both have substantial cylinder structures, and also have the same axis O1-O1′. The housing 20 includes a rectangular sheet 21 and four side walls 23, 25, 27, 29 extending upwards from four edges of the sheet 21. The screw 30 is desired to be positioned in a bottom of the side wall 23. Because of the length of the screwdriver 10, the screwdriver 10 must be inclined to be engaged with the screw 30. Therefore, the tip of the screwdriver 10 may not be suitable fixed in the slot of the screw 30 head and the screwdriver may slip out of the slot when the screw 30 is being driven or the screw 30 head may be damaged.

Therefore, an electric screwdriver is needed in the industry to address the aforementioned deficiency.

### BRIEF DESCRIPTION OF THE DRAWINGS

FIG. 1 is a schematic diagram showing an electric screwdriver in accordance with an exemplary embodiment, for fastening a screw in an apparatus.

FIG. 2 is a schematic diagram showing the electric screwdriver including a rack cover.

FIG. 3 is a schematic diagram showing the electric screwdriver without the rack cover.

FIG. 4 is a disassembled view of the electric screwdriver.

FIG. 5 is a partial enlarged view of the circled portion V of FIG. 4.

FIG. 6 is a schematic diagram showing a conventional electric screwdriver.

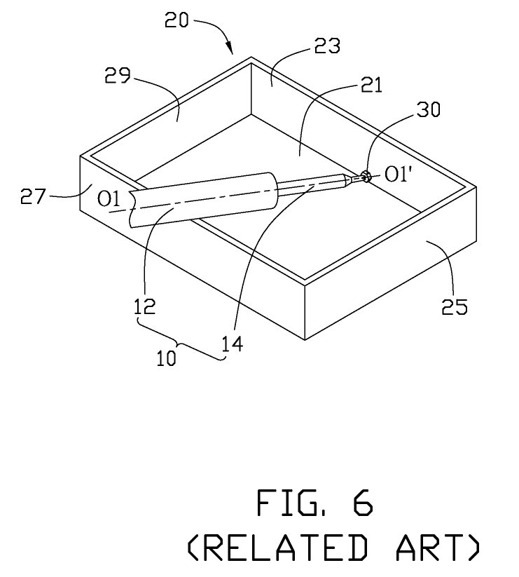

### DETAILED DESCRIPTION

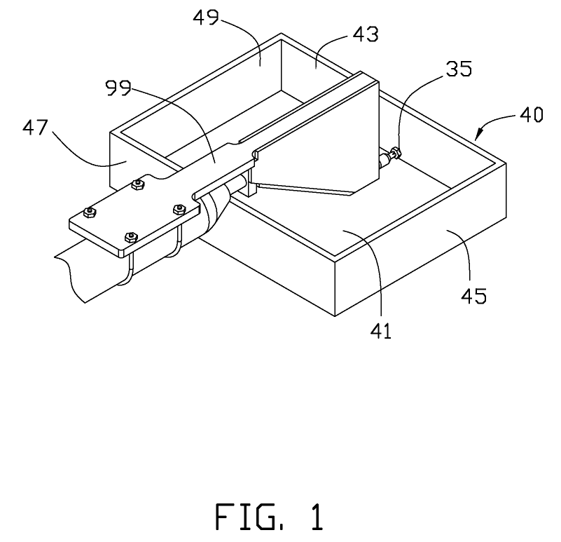

Referring to FIG. 1, an electric screwdriver 99 in accordance with an exemplary embodiment is used for fastening a screw 35 in an apparatus 40. The apparatus 40 includes a rectangular sheet 41 and four side walls 43, 45, 47, 49 extending upwards from four edges of the sheet 41. The screw 35 is desired to be positioned in a bottom of the side wall 43. A length of the electric screwdriver 99 is longer than that of the rectangular sheet 41 in a direction perpendicular to the side wall 43.

In order to fasten the screw 35 easily, the electric screwdriver 99 is designed in a special structure that has three main parts: a driving part, a transmission part, and a driven part. Mechanic energy is supplied from the driving part, transmitted by the transmission part, and then used for driving the driven part to fasten the screw 35. The driving part is parallel to the driven part, and the transmission part is slanted between the driving part and the driven part. A length of the driven part is shorter than that of the rectangular sheet 41 in a direction perpendicular to the side wall 43. As a result, the driven part can provide direct mechanic energy on the screw to fasten the screw into the 40.

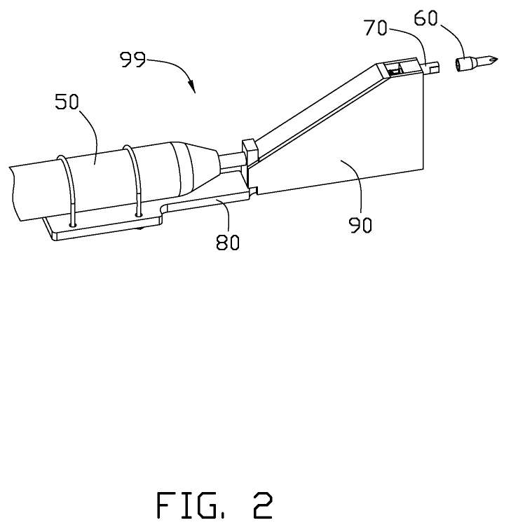

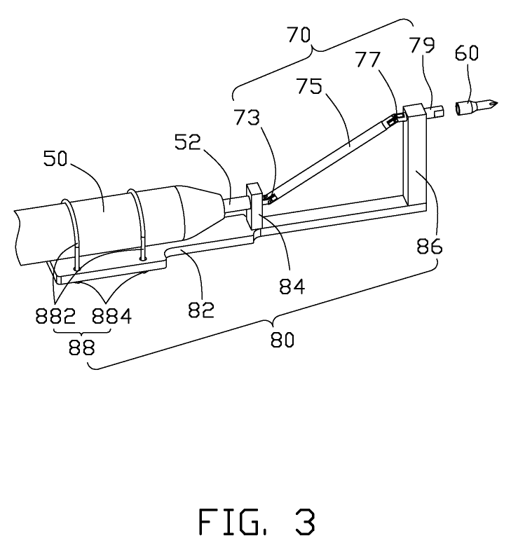

Referring also to FIGS. 2 and 3, a detailed structure of the electric screwdriver 99 includes a driver 50, a detachable head 60, a universal joint chain 70, a supporting rack 80, and a rack cover 90. The driver 50, an example of the driving part, supplies rotary motion and may be an electric motor. The detachable head 60, an example of the driven part, is detachably fixed in the electric screwdriver 99 may have many forms, such as slotted heads, crossheads, hex heads. The drive shaft 70, an example of the transmission part, transmits the rotary motion from the driver 50 to the detachable head 60. The supporting rack 80 supports the driver 50 and the universal joint chain 70. The rack cover 90 further supports the universal joint chain 70.

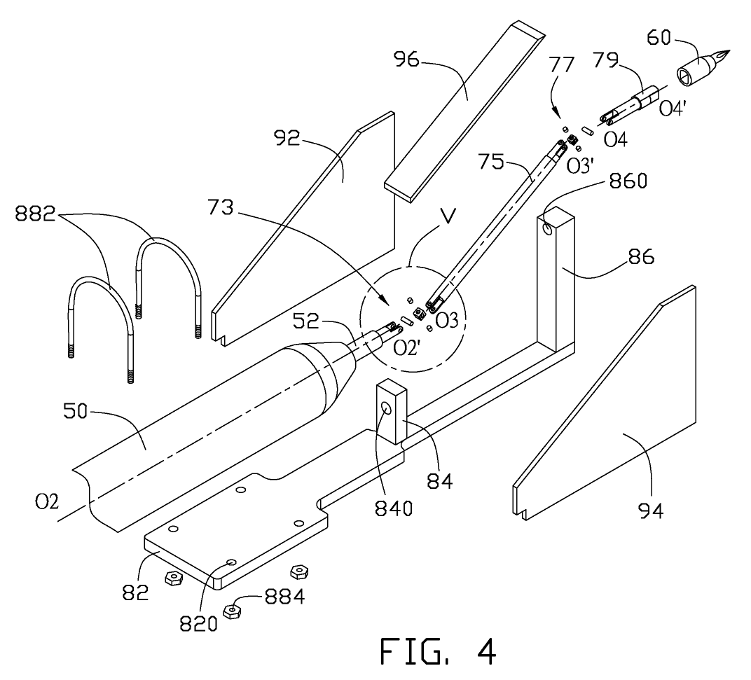

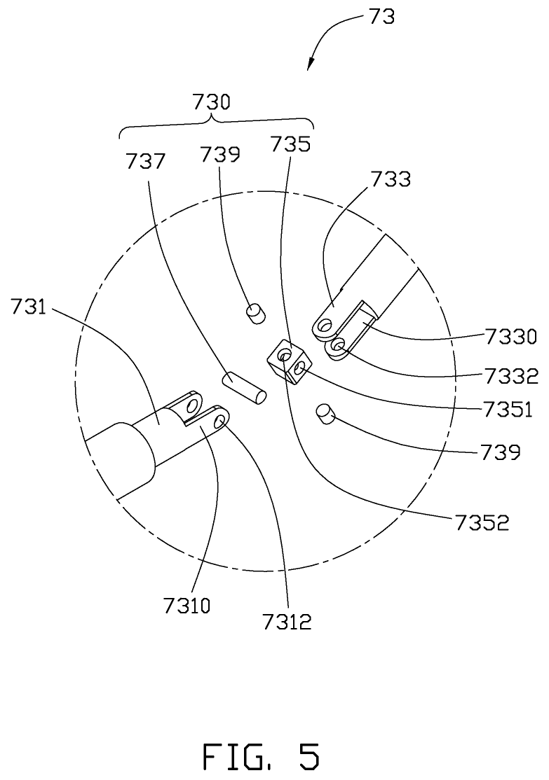

Also referring to FIGS. 4-5, the components of the electric screwdriver 99 are depicted in detail. The driver 50 is a cylinder and includes a first rotatable shaft 52 extending out and connecting with the universal joint chain 70. The first rotatable shaft 52 rotates around a first axis O2-O2′.

The universal joint chain 70 includes a first universal joint 73, a second rotatable shaft 75, a second universal joint 77, and a third rotatable shaft 79. The second rotatable shaft 75 rotates around a second axis O3-O3′, and the third rotatable shaft 79 rotates around a third axis O4-O4′. The first axis O2-O2′is parallel to the third axis O4-O4′. The second axis O3-O3′ is inclined to the first axis O2-O2′ and the third axis O4-O4′. The first universal joint 73 is connected between the first rotatable shaft 52 and the second rotatable shaft 75, for transmitting rotary motion from the first rotatable shaft 52 to the second rotatable shaft 75. The second universal joint 77 is connected between the second rotatable shaft 75 and the third rotatable shaft 79, for further transmitting the rotary motion from the second rotatable shaft 75 to the third rotatable shaft 79.

The supporting rack 80 includes a supporting beam 82, a first supporting member 84, a second supporting member 86, and a fastening member 88 (see FIG. 3). The supporting beam 82 supports the other components of the electric screwdriver 99. The first supporting member 84 is formed on a middle portion of the supporting beam 82. The second supporting member 86 forms on one end of the supporting beam 82. A height of the second supporting member 86 is taller than that of the first supporting member 84. Free ends of the first supporting member 84 and the second supporting member 86 respectively defines a first positioning hole 840 and a second positioning hole 860. The universal joint chain 70 is fixed into the first positioning hole 840 and the second positioning hole 860, and is supported above the supporting beam 82 by a combination of the first supporting member 84 and the second supporting member 86. The universal joint chain 70 is disposed at an angle relative to the supporting beam 82. The fastening member 88 fastens the driver 50 on the other end of the supporting beam 82, in other words, the fastening member 88 is opposite to the second supporting member 86 with respect to the first supporting member 84.

The rack cover 90 includes two side walls 92, 94, and a top wall 96. The two side walls 92, 94 are attached to two sides of the supporting rack 80. In order to match inclination of the universal joint chain 70, each one of the two side walls 92, 94 is a rectangular sheet defining a cut out corresponding to the inclination of the universal joint chain 70. The top wall 96 is attached to two inclined edges of the side walls 92, 94. In other cases, the rack cover 90 may be designed in other shapes as long as the other shapes can also effectively enclose the universal joint chain 70.

Furthermore, the first universal joint 73 and the fastening member 88 are depicted in detail hereinafter. Referring to FIG. 4, the fastening member 88 includes two U-shaped bolts 882 and four nuts 884. Each end of the U-shaped bolts 882 defines a threading. Each end of the U-shaped bolts 882 can pass through a corresponding guiding hole 820 defined in the supporting beam 82, and engageable with a corresponding nut 884.

Referring to FIG. 5, the first universal joint 73 includes a spider 730, a first yoke 731 connected with the first rotatable shaft 52, and a second yoke 733 connected with the second rotatable shaft 75. The first yoke 731 and the second yoke 733 engages with the spider 730. The spider 730 can transmit rotation from the first yoke 731 to the second yoke 733.

The first yoke 731 forms two first pins 7310 on two opposite sides and facing each other. The first pins 7310 define first through holes 7312 respectively. The second yoke 733 forms two second pins 7330 on two opposite sides and facing each other. The second pins 7330 define second through holes 7332 respectively. The spider 730 includes a cube 735, a first cylinder pole 737, and two second cylinder poles 739. The cube 735 defines a third through hole 7351 and a fourth through hole 7352 intersecting with each other. The first cylinder pole 737 is fixed in the first through holes 7312 and the third through hole 7351 to support the third through hole 7351 between the first pins 7310. The fourth through hole 7352 is divided into two parts by the first cylinder pole 737. The second cylinder poles 739 pass through the second through holes 7332, and then fixed into the two parts of the fourth through hole 7352. The second universal joint 77 is similar to the first universal joint 73 in structure.

In assembly, the first cylinder pole 737 is fixed in the first through holes 7312 and the third through hole 7351, and then the second cylinder poles 739 are fixed in the second through holes 7332 and the fourth through hole 7352. Therefore, the spider 730 is fixed between the first yoke 731 and the second yoke 733 to construct the first universal joint 73. In the same way, the second universal joint 77 can also be constructed. Two ends of the universal joint chain 70 is fixed into the first positioning hole 840 and the second positioning hole 860, and further engages with the driver 50 and the detachable head 60 correspondingly. The two U-shaped bolts 882 tie the driver 50 to the supporting beam 82 with the four ends of the U-shaped bolts 882 passing through the four guiding holes 820 defined in the supporting beam 82 to engage with the nuts 884 correspondingly. The two side walls 92, 94 are attached to two sides of the supporting rack 80 correspondingly. The top wall 96 is attached to the inclined edges of the side walls 92, 94.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electric screwdriver for fastening a screw to an apparatus comprising:
a driving part for generating rotary motion;
a driven part for fastening the screw to the apparatus using the rotary motion; and
a transmission part nonlinearly connecting the driving part and the driven part, the transmission part capable of transmitting the rotary motion from the driving part to the transmission part.

2. The electric screwdriver according to claim 1, wherein the driving part is parallel to the driven part.

3. The electric screwdriver according to claim 2, wherein the transmission part is slanted between the driving part and the driven part.

4. The electric screwdriver according to claim 3, wherein the transmission part comprises two universal joints.

5. The electric screwdriver according to claim 4, wherein the transmission part comprises a first universal joint, a second universal joint, and a rotatable shaft connected between the first universal joint and the second universal joint.

6. The electric screwdriver according to claim 5, wherein the first universal joint is connected to the driving part, and the second universal joint is connected to the driven part.

7. The electric screwdriver according to claim 4, wherein each one of the universal joints comprises a spider, a first yoke, and a second yoke, and the first yoke and the second yoke engages with the spider.

8. The electric screwdriver according to claim 7, wherein the first yoke is connected with the driving part, and the spider is capable of transmitting the rotary motion from the driving part to the second yoke.

9. An electric screwdriver comprising:
a driver for supplying rotary motion;
a detachable head detachably fixed in the electric screwdriver; and
a universal joint chain capable of transmitting the rotary motion from the driver to the detachable head, the universal joint chain comprising two universal joints nonlinearly connecting the driver and the detachable head.

10. The electric screwdriver according to claim 9, wherein the universal joint chain comprises a first universal joint, a second universal joint, and a rotatable shaft connected between the first universal joint and the second universal joint.

11. The electric screwdriver according to claim 10, wherein the first universal joint is connected to the driver, and the second universal joint is connected the detachable head.

12. The electric screwdriver according to claim 9, wherein the at least one universal joint comprises a spider, a first yoke, and a second yoke, and the first yoke and the second yoke engages with the spider.

13. The electric screwdriver according to claim 12, wherein the first yoke is connected with the driving part, and the spider is capable of transmitting the rotary motion from the driving part to the second yoke.

14. The electric screwdriver according to claim 9, wherein the driver comprises a rotatable shaft extending out and connecting with the universal joint chain.

15. The electric screwdriver according to claim 9, further comprising a supporting rack positioning the driver and the universal joint chain.

16. The electric screwdriver according to claim 15, wherein the supporting rack comprises a supporting beam for supporting the driver and the universal joint chain, a first supporting member forming on substantial middle of the supporting beam, a second supporting member forming on one end of the supporting beam.

17. The electric screwdriver according to claim 16, wherein the second supporting member is higher than the first supporting member.

18. The electric screwdriver according to claim 17, wherein free ends of the first supporting member and the second supporting member respectively defines a first positioning hole and a second positioning hole, and the universal joint chain is fixed into the first positioning hole and the second positioning hole, and is supported above the supporting beam by a combination of the first supporting member and the second supporting member.

19. The electric screwdriver according to claim 18, wherein the supporting rack further comprises a fastening member fastening the driver on a part of the supporting beam, and is opposite to the second supporting member with respect to the first supporting member.

20. The electric screwdriver according to claim 9, further comprising a rack cover for securing the universal joint chain.
